(19) United States
(12) Patent Application Publication
(10) Pub. No.: US 2006/0074764 A1
(43) Pub. Date: Apr. 6, 2006

(54) Apparatus and system for monitoring and managing equipment and services

(75) Inventors: Douglas Schmitt, Round Rock, TX (US); Robert Franklin Feiner, Austin, TX (US); Richard Nhat Nguyen, Austin, TX (US)

Correspondence Address: BAKER BOTTS, LLP, 910 LOUISIANA, HOUSTON, TX, 77002-4995, US

(73) Assignee: Dell Products L.P.

(21) Appl. No.: 10/952,456

(22) Filed: Sep. 28, 2004

(51) Int. Cl. G06Q 30/00

(52) U.S. Cl. 705/26

(57) ABSTRACT

A control center is provided that enables the monitoring of the delivery of parts and/or technicians to a customer's location to correct a problem. The control center is provided with a monitoring tool that enables representatives of one or more organizations to act, in a coordinated fashion, to solve the problem encountered by the customer. The monitoring tool is provided with communications facilities that enable the representatives to acquire and maintain contact with one another and/or with the customer. Real-time data analysis is provided to the monitoring tool for display to the representatives. The real-time data can be used to ensure compliance with contractual obligations, and to ensure the quality of services provided to the customer. Moreover, the control center, because of its communications and real-time data synthesis capabilities, enables a different approach to solving customer problems by organizing resources in a different and more streamlined manner.

### CROSS REFERENCE TO RELATED APPLICATION

This application is related to co-pending U.S. patent application Ser. No. ______ [Attorney Docket No. 061295.1747, DC-0765 1] entitled “System And Method For Managing Data Concerning Service Dispatches” which was filed on Sep. 28, 2004, and U.S. patent application Ser. No. ______ [Attorney Docket No. 016295.1748, DC-07652] entitled “System And Method For Managing Data Concerning Service Dispatches Involving Geographic Features”, which was also filed on Sep. 28, 2004, both of which are incorporated herein by reference for all purposes.

### BACKGROUND

1. Field of the Invention

The present invention relates to control centers. More specifically, the present invention relates to a system and apparatus for coordinating equipment and technicians in order to resolve problems with other equipment.

2. Background of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information processing systems have become more pervasive, they have also become more complex because those systems are tasked more extensively. As a result, failure of the information processing systems can have a significant and deleterious affect on the performance of an organization. As a consequence, companies that manufacture the information processing systems are often asked by their customers to service broken machines. Unfortunately, the original equipment manufacturers are often unable to fix themselves all of the machines because of the latter's disparate locations and, partly, the sheer number of service calls. As a result, the original equipment manufacturer must enlist the services of third party vendors to service many of the broken information processing systems. Sadly, coordination between the original equipment manufacturer can be hampered by poor communication and lack of an identifiable management personality who can compel performance by employees within both organizations. There is, therefore, a need in the art for a system and/or method that coordinates activities between multiple organizations who service equipment at disparate locations.

### SUMMARY OF THE INVENTION

The present invention is useful for those situations where a single individual and/or a team of individuals, are best suited for overseeing and directing the servicing of customer complaints and/or problems. The present invention is composed of one or more methods and apparatuses that are constructed and arranged in such a manner that the single individual is able to direct the resources of both the individual's company, but the representatives of one or more third party vendors in order to arrange the delivery of parts and/or technicians to the customer's location within pre-defined time constraints. The system disclosed herein also has the capability to monitor any or all stages of the service call, and to receive indications, automatically of the success or failure of reaching milestones for the project within a given period of time for that particular milestone.

The system disclosed herein is composed of, in part, a control center that enables the monitoring of dispatches of parts and/or technicians to a customer's location to correct a problem. The control center is provided with a monitoring tool that enables representatives of one or more organizations to act, in a coordinated fashion, to solve the problem encountered by the customer. The monitoring tool is provided with communications facilities that enable the representatives to acquire and maintain contact with one another and/or with the customer. Real-time data analysis is provided to the monitoring tool for display to the representatives. The real-time data can be used to ensure compliance with contractual obligations, and to ensure the quality of services provided to the customer. Moreover, the control center, because of its communications and real-time data synthesis capabilities, enables a different approach to solving customer problems by organizing resources in a different and more streamlined manner.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram illustrating an information handling system;

FIG. 2 is a block diagram illustrating the architecture that supports a control system;

FIG. 3 is a flowchart illustrating an embodiment of a customer service process;

FIG. 4 is a flowchart illustrating one aspect of the customer service process of FIG. 3;

FIG. 5 is a flowchart illustrating one aspect of the customer service process of FIG. 3;

FIG. 6 is a block diagram illustrating the arrangements of components of an embodiment of the control center; and

FIG. 7 is a schematic diagram illustrating the communications capabilities of an embodiment of the system described herein.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered.

### DETAILED DESCRIPTION

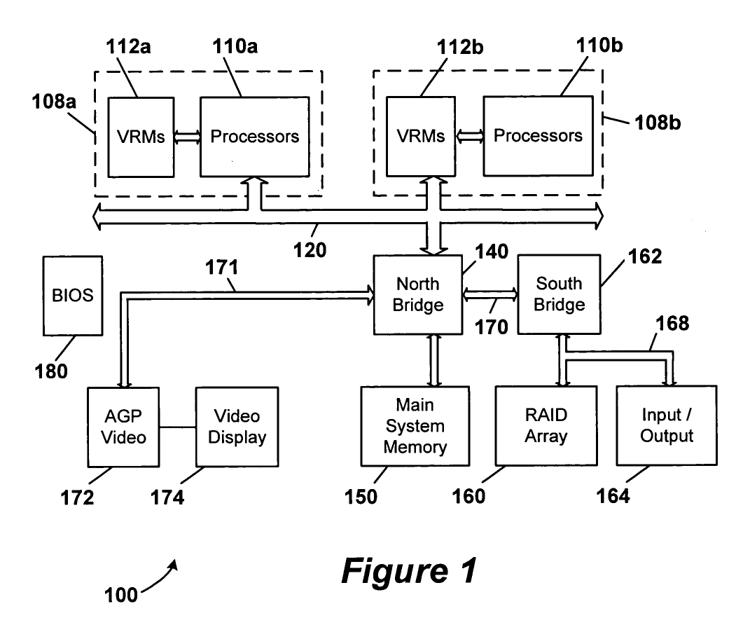

Elements of the present disclosure can be implemented on a computer system, as illustrated in FIG. 1. Referring to FIG. 1, depicted is an information handling system, generally referenced by the numeral 100, having electronic components mounted on at least one printed circuit board (“PCB”) (not shown) and communicating data and control signals there between over signal buses. In one embodiment, the information handling system may be a computer system. The information handling system may be composed processors 110 and associated voltage regulator modules (“VRMs”) 112 configured as processor nodes 108. There may be one or more processor nodes 108, one or more processors 110, and one or more VRMs 112, illustrated in FIG. 1 as nodes 108a and 108b, processors 110a and 110b and VRMs 112a and 112b, respectively. A north bridge 140, which may also be referred to as a “memory controller hub” or a “memory controller,” may be coupled to a main system memory 150. The north bridge 140 may be coupled to the processors 110 via the host bus 120. The north bridge 140 is generally considered an application specific chip set that provides connectivity to various buses, and integrates other system functions such as memory interface. For example, an INTEL® 820E and/or INTEL® 815E chip set, available from the Intel Corporation of Santa Clara, California, provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions, such as main memory control functions, typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The second bus may also comprise other industry standard buses or proprietary buses, e.g., ISA, SCSI, USB buses 168 through a south bridge (bus interface) 162. These secondary buses 168 may have their own interfaces and controllers, e.g., RAID Array storage system 160 and input/output interface(s) 164. Finally, a BIOS 180 may be operative with the information handling system 100 as illustrated in FIG. 1. The information handling system 100 can be combined with other like systems to form larger systems. Moreover, the information handling system 100, can be combined with other elements, such as networking elements and or other information handling systems, to form even larger and more complex information handling systems such as, for example, clusters or other enterprise resource planning system, such as an enterprise resource planning portal.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory as described above. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The information handling system described above, or similar systems, may be used to implement the systems and methods described herein. It should be noted that the information handling system needed to implement the methods and systems described herein may be implemented in hardware, in software (in the form of one or more instructions), or in any combination of hardware or software. Moreover, no specific software language is required to implement the systems and methods described herein, and they may be implemented using any desired programming language.

An information and telecommunications center having one or more individuals having access to a command station is provided. The command station typically comprises a computer (such as a personal computer (“PC”) that is operable with a network. Exemplary networks include, for example, a telecommunications network and a data network, such as the Internet, and the like. The command center may also include with one or more large projection (and/or plasma) screens in a large room, as well as conference facilities, all with access through communications mechanisms such as telephones, facsimile, wireless telegraphy, voice-over IP (“VoIP”), email, etc. to individuals from within multiple organizations, such as an original equipment manufacturer (“OEM”) and one or more third-party vendors that supply parts and/or labor services. One or more of the command stations within the command center may interact and/or manipulate one or more elements of the command center, or one or more resources associated with one or more organizations. Typically, individuals, such as dispatchers or other representatives, will interact with the command center through the command station. However, groups of people may coordinate activities through their respective command stations via the communications capabilities of the command center.

The command center may have the ability to track, for example, trucks and/or personnel at remote facilities to ensure that parts and services arrive at a customer's facility within, for example, pre-defined time limits and/or in a manner needed to minimize cost. The individuals within the command center may provide dispatching services and the command center enables those individual to dispatch and to monitor the services to a much higher degree than previous systems. Because the servicing of problems is streamlined and optimized, the same number of individuals can service additional customers, or service customers that were unable to be serviced before the advent of the control center disclosed herein.

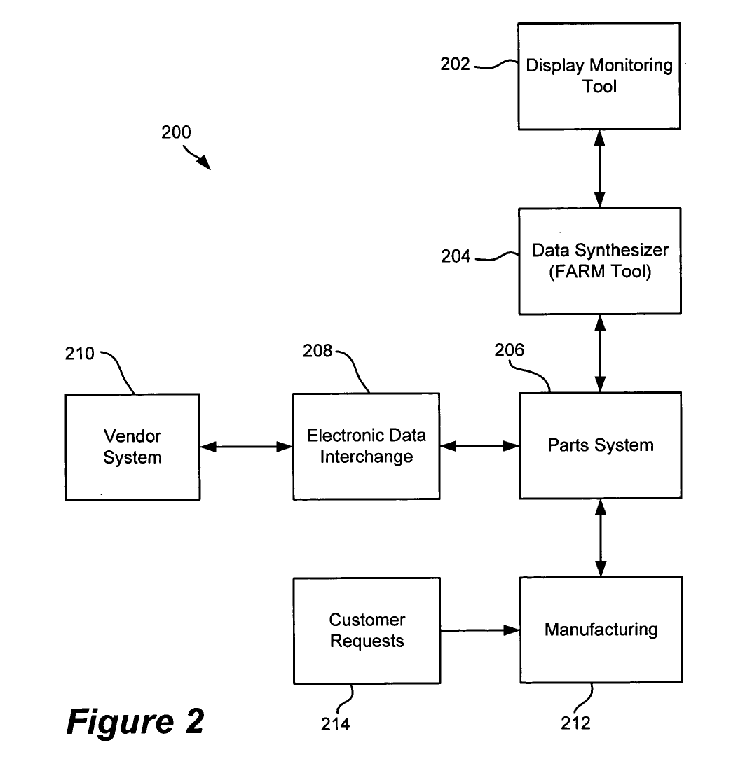

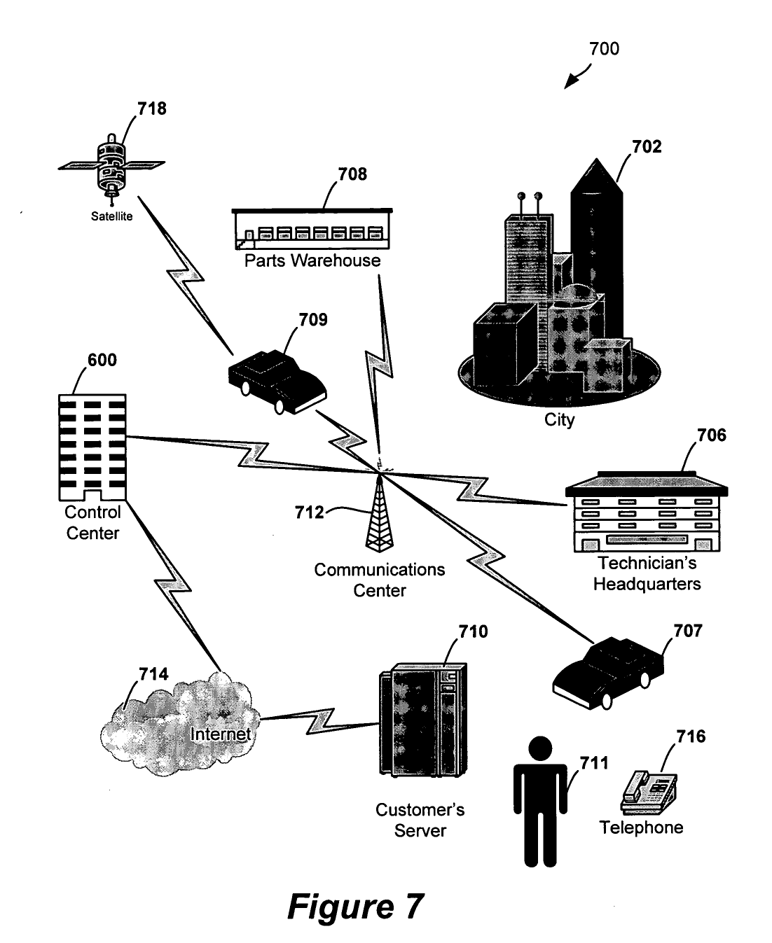

FIG. 2 illustrates a broad diagram of the system disclosed herein. Long before any problems are encountered, the customer 214 has made a request to the manufacturing operation 212 to order, for example, a computer server 710 (see also FIG. 7). The manufacturing operation 212 in turn, requests parts from the third party manufacturers 210 via, for example the parts system 206 and electronic data interchange (“EDI”) 208. The order for the parts, and in what machine those parts are eventually installed can be recorded by the parts system 206. The parts system 206 may play a central role in the system 200 disclosed herein. Because the part system 206 is also used, and has interaction capability through EDI 208 with one or more vendors 210, each vendor, a communications system is established. Typically each vendor 210 has their own unique system for handling transactions. However, the user of the mutually agreeable EDI 208 ensures appropriate communication capability, namely for the transactions being requested for parts and services to satisfy the customers requests. The communications through the EDI 208, therefore, may be established and maintained throughout the relationship between the vendor and the OEM. After the machine 710 has been created by manufacturing 212, it is sent and installed at the customer 214. Thereafter, problems may arise, either through the software used, or with the hardware making up the machine 710. Upon a call from the customer, the data synthesizer 204 may be used to retrieve information from the parts system 206, synthesize the data and, for example, display the information to the display monitoring tool 202. Similarly, if new parts are needed to satisfy a customer complaint, parts or services can be ordered from the vendor 210 via the EDI 208.

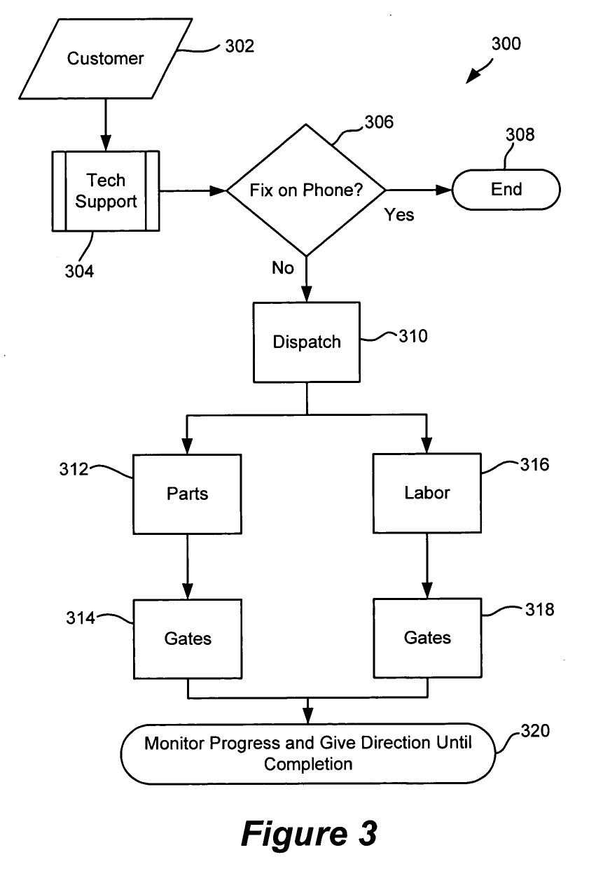

FIG. 3 illustrates the method 300 for servicing a customer service call. The customer 302, calls for technical support from the OEM in step 304. In step 306, the tech support person determines whether or not the problem has been solved over the course of the telephone call. If so, then the method 300 ends in step 308. Otherwise, a dispatch for parts and/or on-site technical service is made in step 310. The dispatch has one or two components—either a parts component 312, and/or a labor component 316. In other words, a dispatch may be for one or more part only, it may be labor only, or it may be for a combination of parts and labor. For each part 312 and for each portion of labor 316, one or more gates may be created in steps 314 and 318 respectively. The gates 314 and 318 are used by the monitoring tool to ensure that the customer support is being performed within established guidelines and/or within contractual limits. After the gates 314 and 318 have been set, the progress is monitored and one or more individuals of the OEM and/or any of the third party vendors may be employed until the completion of the customer's request in step 320.

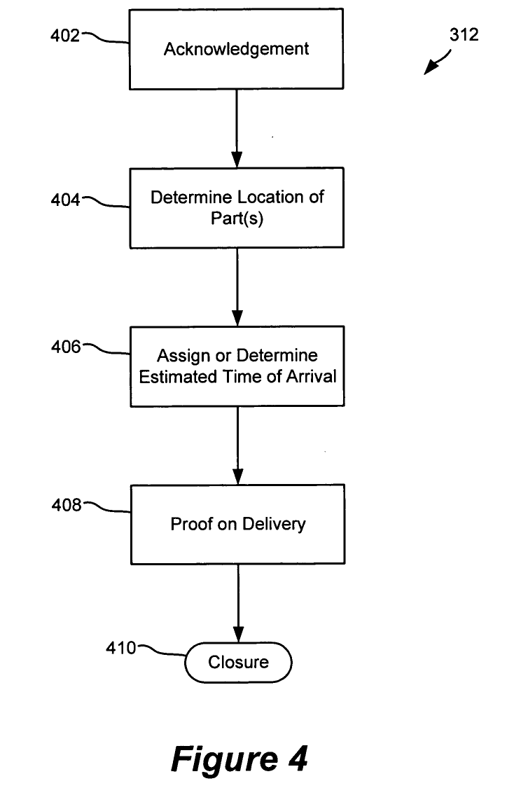

Steps satisfying the parts aspect 312 are illustrated in FIG. 4. The request for one or more parts is acknowledged by the parts vendor in step 402. In step 404, the parts vendor may determine where the needed parts are located with respect to the customer's location. In step 406, based upon the determination made in step 404, the parts vendor will determine the best route to get the parts to the customer's location in the least amount of time, for the lowest cost fashion, or some other figure of merit. The estimated time of arrival for the parts may then be communicated to the control center to help the OEM coordinate the activities to solve the customer's problem. In step 408, the part is shipped to the customer's location, and upon delivery, proof of delivery may be indicated either to the customer and/or to the OEM that is coordinating the activity and the method ends generally in step 410.

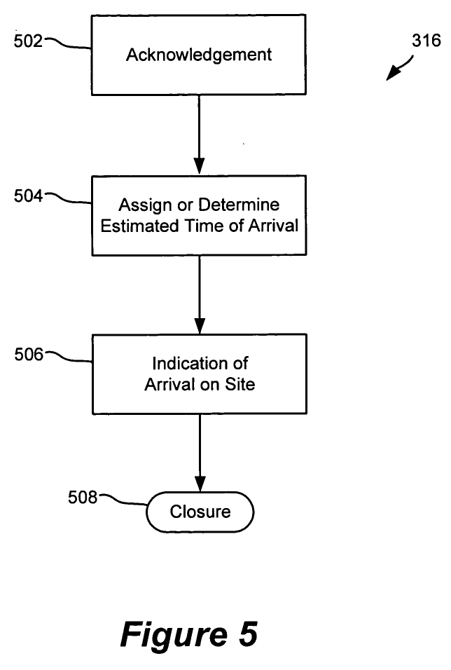

FIG. 5 illustrates the labor step 316 of FIG. 3. Specifically, the labor may include technicians and/or other individuals necessary to service the customer's request. The method 316 begins generally at step 502, where an acknowledgement of an OEM's or customer's order. In step 504, the vendor may determine how many technicians are needed, which technicians are needed, where those technicians are currently located, and how long it will take those technicians to arrive at the customer's location. At that point, the vendor may assign or determine the estimated time of arrival for the requisite technicians at the customer's location. In step 506, once the requisite number of technicians has arrived, an indication of their arrival is made to the OEM and/or the customer and the method ends generally in step 508.

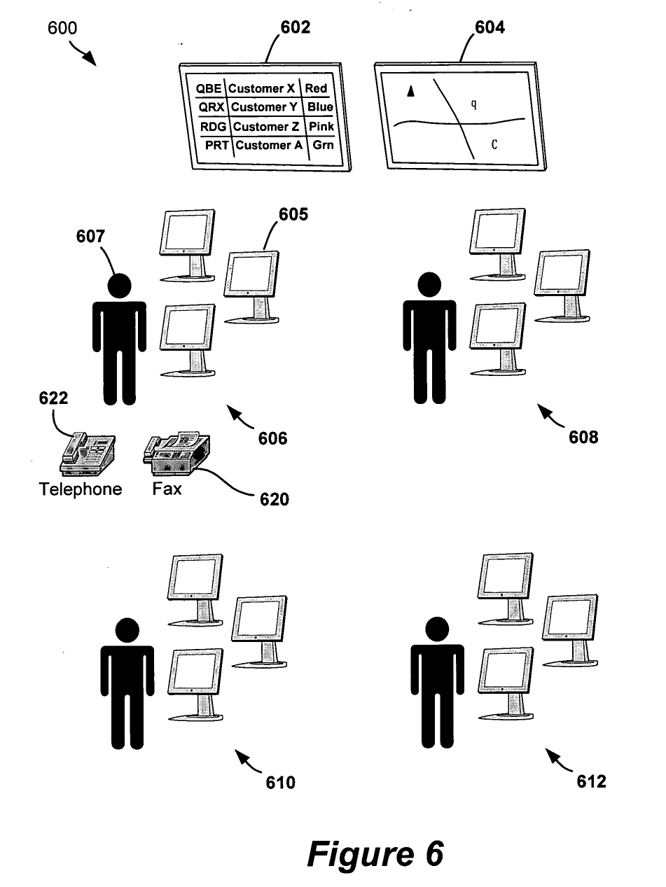

FIG. 6 illustrates the command center disclosed herein. Specifically, the monitoring tool 600 has several components, namely, one or more large displays 602 and 604 which may contain information regarding specific customer requests or groups of requests. Alternatively, one or more of the displays 602, 604 could show, for example, a map. In one embodiment, the screens are large enough and are position in room where one or more people may view the monitors simultaneously in order to facilitate the coordination of activities. For example, not only the particular dispatchers themselves may have a view of the large monitors, but also their managers and/or customers and/or third party vendors such as the parts and the technician vendors. Within the control room 600 are one or more workstations 606, 608, 610, and 612. While four work stations are depicted in this embodiment, it will be understood that one or more work stations can be placed within the command center 600, and that the system disclosed herein is scalable to accommodate as many workstations as time and resources permits. Each of the workstations has one or more monitors 605 that are viewable by a representative 607. Representatives 607 can be employed, for example, by the OEM that is responsible for service in the support contract with the customer, or the representative 607 may represent one of the third party vendors that supplies parts or provides technicians. Additional facilities, such as conference rooms and the like, can be utilized with the control center 600. Each of the monitors 605 can be associated with a separate information handling system, or may access the same information handling system, such as the one depicted in FIG. 1. Each workstation, 606, 608, 610, and 612 can be outfitted with one or more fax machines 620 and/or one or more telephones 622, or other communications devices. Moreover, the information handling system has a network facilities that can access wide area networks such as the internet, to provide, for example, e-mail, web connections, IRC chat connections, and the like. Moreover, the command center 600 can be connected to, or be a part of, for example, the monitoring tool 202 of FIG. 2. Elements of the command center 600 may also be connected to, for example, the data synthesizer 204 in order to display information on, for example, display monitors 602, 604 and 605. Moreover, the parts system 206 may be used, via the data synthesizer 204, to display geographic locations of parts and/or equipment on, for example, the map on monitor 604.

FIG. 7 depicts the intercommunications capabilities of the control center and the overall operation of the system disclosed herein. Specifically, the control center, 600, may reside within or outside of the city 702, where the customer's machine 710 is located. The customer's machine 710 can, for example, transmit a fault indication upon detecting an error or other indication that a part within the server has or is about to fail. The fault indication can be transmitted via, for example, the Internet 714 to the control center 600 for automated handling by dispatchers of the OEM that reside in the control center 600. Alternatively, a user 711 may employ the telephone 716 to contact the control center 600 to issue a complaint or request for service. Thereafter, the control center 600 may via, for example, the telecommunications center 712 or via the Internet 714, contact the parts warehouse 708 and the technicians headquarters 706 to request the delivery of parts and/or services at the customer's location 710. The parts warehouse 708 may have sufficient capacity to provide the parts needed, and may transport them via, for example, the vehicle 709, to the customer location 710. Similarly the technicians headquarters 706 may communicate with one or more technicians, either within their own facility 706, or at remote locations and ensure that the appropriate technicians arrive at the customer location 710 via, for example, vehicle 707 as illustrated in FIG. 7. The parts transported, and/or the technicians in their respective vehicles 709 and 707, can be tracked and their respective positions correlated (perhaps in real-time) via, for example, RFID tags, telecommunications services, and/or the satellite 718. GPS capabilities maybe also be employed to help track the positions of parts and/or technicians.

The system outlined above, while normally used reactively, may also be employed in a proactive manner. In other words, disaster scenarios may be used as input to dispatchers and databases alike, so that different reactions and solutions may be attempted. The various solutions attempted can be evaluated at leisure in order to find an optimum solution, or to discover additional capacity that may then be offered to existing or future customers.

As mentioned previously, the command center 600 receives information from one or more databases that are part of the architecture illustrated in FIG. 2. The databases can be internal to an organization, external to the organization, or a mix of internal and external databases. Moreover, the databases may reside in, for example, the parts system 206, the data synthesizer 204, or within the vendor's system 210. Other embodiments of the system may have one or more databases contained in the same or other elements of the architecture.

In one embodiment, a four-hour automated monitoring (“FARM”) application tool is used with the data synthesizer 204. The FARM application may be used to retrieve data from multiple databases for use with the command center 600. The data from the various databases is periodically accessed in order to refresh the information provided to the command center. The FARM application tool 204 receives data from, for example, the OEM, as well as third-party organizations. The third-party organizations may handle the tracking of parts and/or services that are in the logistical pipeline, either to or from the OEM and/or the customer. The third party vendors may be informed by the OEM, via the command center's 600 communication mechanism.

In another embodiment, software tools and/or databases may supply information to, or be used in conjunction with, or accept information from, the FARM tool 204. The command center 600 may use certain sorting capabilities to extract and order data that is selected from the FARM tool 204. Sorting the information can convey the information in a more useful manner so that an individual, such as the OEM's dispatcher, can make better use of the information, and thus better handle the customer's problem. To that end, the databases may be queried and/or updated periodically (or nearly continuously) as needed for the desired level of performance, accuracy and responsiveness.

The system of the present invention may include authentication and authorization mechanisms. The authentication and authorization mechanisms can be applied to the dispatchers, the third-party vendors and/or the customers. The authentication and/or authorizations mechanisms can be incorporated into interfaces that communicate with, for example, the parts system 206, the monitoring tool 202, and/or the FARM tool 204.

As mentioned previously, the parts system 206 may aid in the logistics of the system by recalling the location of the customer's machines by, for example, associating the customer's machine with a tag number. A service call to the OEM by the customer may reference the tag number of the machine. The parts system 206 can be referenced by the dispatcher 607 in the command center 600 and the exact configuration (e.g., the processor, RAM, operating system, etc.) of the machine 710 can be obtained and correlated against the supply of parts and technical capabilities of the vendors 708 and 706, respectively. The location of the machine 710 is identified to third-party vendors 708 and 706, and technicians and/or parts are dispatched to the customer's location within the limits of, for example, the service level agreement. Third-party vendors 708 and 706 can access necessary information from the system 200 (such as the parts system 206) so that specific information, such as the exact nature of the problem, the make and model of the machine, or the exact location of the machine, can be obtained. For example, information from the parts system 206 and/or the FARM tool 204 may be accessed via the World Wide Web of the Internet 714 to enable the third party vendors to access the needed information. Alternate communications channels, such as cellular telephones, may be used for the same purpose. Similarly, the third-party vendor may also establish web pages for the use of the OEM's dispatcher 607.

The system disclosed herein may also be able to distinguish parts in kits as available for service use. A kit is typically an assembly of individual parts, typically for a particular purpose. In some instances, however, kits have to be compromised so that an individual part can be employed when an individually packaged part is not available. The system disclosed herein may track the compromise of the kit, and automatically order a replenishment part so that the kit can be made whole.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A system comprising:
a parts system,
a data synthesizer operative with the parts system;
a monitoring tool operative with the data synthesizer; and
a vendor system operative with the parts system;
wherein users using the monitoring tool may request services from the vendor system.

2. The system of claim 1, wherein the vendor system and the parts system communicate via an electronic data interchange.

3. The system of claim 1, wherein the parts system has one or more databases.

4. The system of claim 1, wherein the data synthesizer has one or more databases.

5. A method for servicing requests comprising:
receiving a technical support call from a customer;
determining if the technical support call can be serviced by telephone and, if not, then creating a dispatch having an element consisting of the group of parts and labor;
generating one or more gates for each element; and
monitoring the servicing of the request.

6. The method of claim 5, wherein the dispatch of a part consists of:
acknowledging the request for one or more parts;
determining the location of the one or more parts;
determining the estimated time of arrival of the parts to a customer location; and
indicating delivery of the one or more parts to the customer location.

7. The method of claim 5, wherein the dispatch of a part consists of:
acknowledging the request for one or more technicians;
determining the estimated time of arrival of the technicians to a customer location; and
indicating the arrival of the one or more technicians to the customer location.

8. A control center comprising:
a room;
one or more large displays within the room, the displays operative with one or more databases;
one or more workstations within the room, the workstations operative with the one or more databases; and
one or more communications services, the one or more communication services constructed and arranged to enable users of the workstations to communicate with one or more individuals and with the one or more databases.

9. The control center of claim 8, wherein one of the one or more communications services is the Internet.

10. The control center of claim 8, wherein one of the one or more communications services is a telecommunication service.

11. The control center of claim 8, wherein one of the one or more communications services is a telephone.

12. The control center of claim 8, wherein one of the one or more communications services is a facsimile.

13. The control center of claim 8, wherein one of the one or more communications services is email.

14. The control center of claim 8, wherein one of the one or more communications services is IRC chat.

15. The control center of claim 8, wherein one of the one or more databases is a FARM application tool.

16. The control center of claim 8, wherein one of the one or more databases is a parts system.

17. The control center of claim 8, wherein one of the one or more individuals is a manufacturing operation.

18. The control center of claim 8, wherein one of the one or more individuals is a customer.

19. The control center of claim 8, wherein one of the one or more individuals is a technician.

20. The control center of claim 8, wherein one of the one or more individuals is a parts vendor.

21. The control center of claim 8, wherein one of the one or more individuals is a vendor.

22. The control center of claim 8, wherein one of the one or more databases is a vendor system.

23. The control center of claim 8, wherein one of the one or more communications services is an electronic data interchange.
